(19) United States
(12) Patent Application Publication
(10) Pub. No.: US 2007/0023632 A1
(43) Pub. Date: Feb. 1, 2007

(54) System and Method for Analysis of Compounds Using a Mass Spectrometer

(76) Inventor: Byron KIESER, Beeton, ON (CA)

Correspondence Address: TORYS LLP, 79 WELLINGTON ST. WEST, SUITE 3000, TORONTO, ON, M5K 1N2, CA

(21) Appl. No.: 11/421,970

(22) Filed: Jun. 2, 2006

Related U.S. Application Data
(60) Provisional application No. 60/686,920, filed on Jun. 3, 2005.

(51) Int. Cl. B01D 59/44

(52) U.S. Cl. 250/282

(57) ABSTRACT

Systems, methods, and computer programming for identifying, and/or verifying the identification of, substances through the use of mass spectrometers. A plurality of analytes of known composition are added to an analyte of unknown composition, and the combination(s) are analyzed. Data acquired during the analysis are compared to each other, and/or to known or expected reference data. The comparisons are used to identify substances comprised by the analyte of unknown composition, or to verify the identification of such substances.

### CROSS-REFERENCE TO RELATED APPLICATIONS

This application claims the benefit of U.S. provisional patent application Ser. No. 60/686,920 filed 3 Jun. 2005 and entitled System and Method for Analysis of Compounds Using a Mass Spectrometer.

### FIELD OF THE INVENTION

The invention relates to compound analysis, and more particularly to systems and methods for analysis of compounds using mass spectrometers. A new approach is provided to the collection of data in, for example, multiple target screening mass analyses using multiple reaction monitoring (MRM) transition. The approach reduces the burden on chromatographic separation and peak integration through the use of multiple standard additions.

### BACKGROUND OF THE INVENTION

Mass spectrometry, also called mass spectroscopy, is an instrumental approach that allows for the mass measurement of molecules. Mass spectrometers have become pivotal for a wide range of applications in the analysis of inorganic, organic, and bio-organic chemicals. Examples include dating of geologic samples, drug testing and drug discovery, process monitoring in the petroleum, chemical, and pharmaceutical industries, surface analysis and the structural identification of unknowns. Further, mass spectrometry is being continually improved and has recently had significant advances in its application to molecular biology, where it is now possible to analyze proteins, DNA, and even viruses.

A mass spectrometry system typically includes an ion source, a mass analyzer, and a data collection device interfaced with or integral to a computer, data processor, or other controller. The combination of such devices enables a mass spectrometer to determine the molecular weight of chemical compounds by ionizing, separating, and measuring molecule-sized particles according to their mass-to-charge ratios (m/z). Ions may be generated in the ionization source by inducing either the loss or the gain of charge (e.g. electron ejection, protonation, or deprotonation). Once ions are formed they can be directed into a mass analyzer and detected. The ionization and detection of a mass using a mass spectrometer can be used to generate a mass-to-charge ratio (“m/z”) spectrum that can provide molecular weight information.

Many applications require the simultaneous analysis of many compounds in complex matrices. Because of the complexity of the samples, matrices and number of analytes, chromatography complements a spectrometer's inherent ability to scan many multiple reaction monitoring (MRM) transitions quickly by spreading release of the analyte compound in time. A standard method used today provides results based on the detection of compounds as peaks in an extracted ion chromatogram or MRM trace. There are many challenges to analyzing data from such experiments, in particular relating to the ability to readily identify compounds of interest as peaks in a chromatogram and to reliably indicate the presence or absence of compounds relative to regulatory guidelines. These difficulties can reduce productivity in many markets that use these experiments including food and beverage, forensics, environmental, drug screening, clinical toxicology and clinical diagnostics.

### SUMMARY OF THE INVENTION

The invention provides systems, methods, and computer programming for identifying, and/or verifying the identification of, substances through the use of mass spectrometers. A plurality of analytes of known composition are added to an analyte of unknown composition, and the combination(s) are analyzed. Data acquired during the analysis are compared to each other, and/or to known or expected reference data. The comparisons are used to identify substances comprised by the analyte of unknown composition, or to verify the identification of such substances.

For example, in one aspect the invention provides methods of analysing ions using mass spectrometers, such methods including, for example, providing in a mass spectrometer an analyte comprising ions of unknown identities and concentrations; providing in the mass spectrometer with said analyte a plurality of analytes comprising ions of known identities and concentrations; using the mass spectrometer, acquiring data representing mass and intensity characteristics of ions comprised by the combined known and unknown analytes; using a processor associated with the mass spectrometer, comparing the data representing mass and intensity characteristics; and, using the comparison, identifying at least one substance comprised by the analyte comprising ions of unknown identities and concentrations.

In related aspects, the invention provides such methods wherein, using the comparison of data representing mass and intensity characteristics, an identification of at least one substance comprised by the analyte comprising ions of unknown identities and concentrations is verified.

As a further example, in another aspect the invention provides computer programming media adapted for causing a data processor to compare data representing mass and intensity characteristics of ions analyzed by a mass spectrometer, the data acquired by the mass spectrometer by analyzing a combination of analytes, the analytes comprising at least one an analyte comprising ions of unknown identities and concentrations and a plurality of analytes comprising ions of known identities and concentrations; and to use the comparison to identify at least one substance comprised by the at least one analyte comprising ions of unknown identities and concentrations.

In related aspects, the invention provides such programming wherein the programming causes the processor, using the comparison of data representing mass and intensity characteristics, to verify an identification of at least one substance comprised by the analyte comprising ions of unknown identities and concentrations.

Thus the invention provides means for reducing the relatively low efficiency imposed by the need for human review and comparison required in prior art systems. The invention enables a readily-calculated assessment which provides clear indications of the presence of analytes in samples, with little need to review peaks manually. The invention finds particular applicability in, for example, LC/MS/MS analyses, particularly in the environmental, food and beverage, forensics, clinical diagnostics and toxicology fields, where there often exist needs to screen for relatively large numbers of compounds quickly.

### BRIEF DESCRIPTION OF THE DRAWINGS

The invention will now be described by way of example only, and with reference to the accompanying drawings, in which:

FIG. 1 is a schematic block diagram of a mass spectrometry system suitable for use in implementing the invention.

FIG. 2 is a schematic flow diagram of a process for processing data in accordance with the invention.

### DETAILED DESCRIPTION OF THE INVENTION

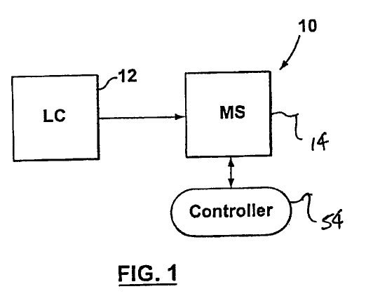

FIG. 1 shows basic components of a mass spectrometry system 10 suitable for use in implementing the invention. System 10 comprises ion source 12, including for example a liquid chromatography column, 12 coupled to a mass spectrometer 14 capable of conducting multiple stages of mass spectrometry. Examples of such a system include the QSTAR®, API 3000™ and API 4000™ LC/MS/MS systems marketed by MDS Sciex, although those skilled in the art will appreciate that the invention can be implemented using any suitably-controlled system that has MS and MS/MS or other multi-MS capabilities (e.g., a 3D trap or time-of-flight (TOF) analyzer). Data acquisition controller 54 enables automated MS to MS/MS acquisition for maximum efficiency of, for example, extraction of information from single or multiple LC/MS runs.

Controller or processor 54 is adapted for receiving, storing, and/or otherwise processing data signals acquired or otherwise provided by mass spectrometer 14, and for providing command signals adapted for the control of operations performed by mass spectrometer 14; and for processing data signals to, for example, compare mass and intensity data corresponding to ions detected during analysis of analytes. Processor 54 can further provide user interfaces suitable for controlling the MS system 10, including for example input/output devices suitable for accepting from the user and implementing system commands, displaying and otherwise controlling output, etc.. In particular, controller 54 can be adapted for processing data acquired by mass spectrometer 14 and providing to mass spectrometer 14 command signals for use in controlling mass analyses conducted by the spectrometer, determined at least in part on information generated by the processing of such data, and data reduction and comparisons as described herein.

Controller or processor 54 can comprise any data-acquisition and processing system(s) or device(s) suitable for use in accomplishing the purposes described herein. Processor 54 can comprise, for example, a suitably-programmed or -programmable general- or special-purpose computer, or other automatic data processing equipment, with associated programming and data acquisition and control devices. Processor 54 can be adapted, for example, for controlling and monitoring ion detection scans conducted by mass spectrometer 14; and for acquiring and processing data representing such detections by mass spectrometer 14 of ions provided by, for example, liquid chromatography (LC) column 12, as described herein.

It should be noted that controller or processor 54 need not, for the purposes disclosed herein, be incorporated as a part of mass analyzer or mass spectrometer 14, as for example by inclusion in a common hardware cabinet or by connection to a common bus-type connection. Controller or processor 54 may be provided as a stand-alone computer connected to the mass spectrometer 14 by a suitable local or remote internet connection, or in any other manner consistent with the purposes disclosed herein.

Accordingly, processor 54 can comprise one or more automatic data processing chips adapted for automatic and/or interactive control by appropriately-coded structured programming, including one or more application and operating system programs, and any necessary or desirable volatile or persistent storage media. As will be understood by those of ordinary skill in the relevant arts, once they have been made familiar with this disclosure, a wide variety of processors and programming languages suitable for implementing the invention are now available commercially, and will doubtless hereafter be developed. Examples of suitable controllers, comprising suitable processors and programming are those incorporated in the QSTAR®, API 3000™ or API 4000™ LC/MS/MS systems available through MDS Sciex of Ontario, Canada.

Ion sources suitable for use in implementing the invention can comprise any LC column or other ion source 12 compatible with the purposes disclosed herein. For example, as will be apparent to those skilled in the relevant arts, any liquid chromatography or other sustained-release ion source(s) will serve. The invention can be particularly effective when implemented in combination with LC columns and other ion sources that produce sustained or other streams of ions of varying character.

Mass spectrometer 14 can comprise any ion detector and/or other mass analyzer(s) compatible with the purposes disclosed herein. For example, as will be apparent to those skilled in the relevant arts, 3D ion traps, TOF detectors, and other types of mass spectrometers will serve. The invention is particularly useful in combination with mass spectrometers capable of repeated or recursive scans or other samplings of ion groups.

Mass spectrometer 14 comprises a detector that allows mass spectrometer 14 to generate data signals signal in accordance with the ions that have been detected. Such data signals generally include mass-related signals corresponding directly or indirectly to characteristics of ions detected by the mass analyzer(s) comprised by mass spectrometer 14, such as mass-to-charge, time-of-flight, and charge intensity data. For example, according to an embodiment in which a TOF process is used for mass analysis, different ions reach the detector at different times. For example, smaller ions can reach the detector first because of their greater velocity and larger ions can take longer. Thus, m/z may determined according to an ions' time of arrival at the detector, through the use of mass-related data signals representing the time of flight of the ions within the TOF mass analyzer.

In a present embodiment, spectrometer 14 is coupled with a chromatography system in order to identify and characterize eluting species from a test sample. Accordingly, output of a liquid chromatograph 12 is coupled to mass spectrometer 14 to provide sample including target analytes for analysis. Such target analytes typically include ions of unknown identities and concentrations.

For example, to carry out analysis using the coupled system, an eluting sample is ionized and a series of mass spectrograms are obtained of the ionized analytes at specified intervals, ranging from, for example, 0.01-10 seconds, for subsequent data analysis. The sample is typically found in a matrix.

Confidence in the detection and analysis of targeted analytes can be enhanced through a series of standard injections at known levels, so as to enable comparisons of expected peak ratios between injections. Such standard injections may be described as analytes which include ions of known identities and concentrations. Such comparison of expected peak ratios can reduce uncertainty associated with finding small peaks by, for example, eliminating matrix effects and hence improving confidence in peak detection. Instead of relying on absolute peak areas for confirmation, according to this method, the ratio of two or more peaks and the difference in peak areas is considered. Also, the ratio of peak areas to amounts in the standard injections can be effectively used to internally calibrate on a run to run basis. Thus methods according to the invention can provide minimum calibration curves for each sample, reducing the time required for reviewing data.

In some circumstances, it can be advantageous to employ an ‘echo’ approach, in which standards are co-injected at different times during the analysis run, or to employ labelling techniques such as iTRAQ and iCAT.

It can be advantageous in practicing the invention to minimize the net runtime per sample of an analysis by, for example, providing known amounts of standards in each sample at easily-integrated levels. This can for example reduce the reliance on chromatographic separation and reduce run times. In addition, the automatic data review process performed by the controller 16 may be greatly simplified, saving time spent in data processing.

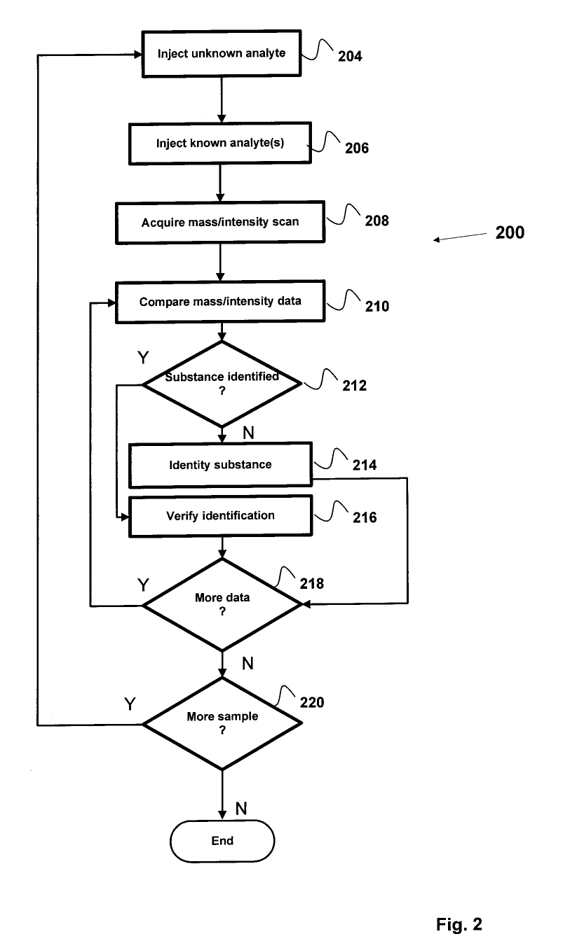

FIG. 2 is a schematic flow diagram of a process 200 for processing data in accordance with the invention, suitable for implementation on a system such as that shown in FIG. 1.

At 204 one or more analytes comprising ions comprising ions of unknown identities and concentrations are provided to the mass analyzer 14 for analysis. Such ions may be provided, for example, by injection of sample provided by an LC column or other ion source 12 into the mass analyzer 14.

At 206 one or more analytes, i.e., standard samples, comprising ions of known identities and concentrations are provided in the mass analyzer 14. Such standard analytes may be provided at the same time as the analyte(s) provided at 202. Moreover, a series of multiple standards may be provided over time, so that introduction of the various standards is offset. Introduction of such standards may overlap, and/or may take place sequentially.

At 208 mass analyzer 14 analyzes the analytes introduced at 204, 204, and provides output signals representing characteristics of detected ions, including for example mass-charge ratios, times-of-flight determined by TOF analysis, and charge intensities. Charge intensities, as will be understood by those skilled in the relevant arts, typically correspond to the relative numbers of ions detected.

At 210 a processor compares data provided by the mass analyzer 14 at 206 to determine absolute and/or relative amounts of ions detected, and for example to compare such absolute and relative amounts to each other, in order to assist in the identification of substances included within the test analyte(s). For example, a processor associated with a controller 54 communicatively linked to mass analyzer 14 can process the data in real time, in order to assist further analysis. Alternatively, the same or another processor can process the data at another time, as for example using analysis data stored for later processing in a database.

At 212 the processor can make a determination as to whether the substances(s) analyzed at 208, 210 have previously been identified.

If the substance(s) analyzed at 208, 210 have not previously been identified, at 214 the processor can make an identification of the substance(s). For example, by preparing actual or virtual mass spectrograms for use in comparison of peak values of ions of various mass-to-charge ratios detected during one or more scans of an MS of MS/MS run, a processor associated with a mass analyzer 14 can identify one or more substances in the compounds analyzed.

A number of processes for comparing peak or other values associated with ions through elution, etc., are known, and doubtless others will be hereafter developed. As will be understood by those skilled in the relevant arts, when they have been made familiar with this disclosure, a wide variety of such processes are suitable for use in implementing the invention.

If the substance(s) analyzed at 208, 210 have been previously, or tentatively, identified, at 216 the processor can verify the previous or tentative identification. For example, by preparing actual or virtual mass spectrograms for use in comparison of peak values of ions of various mass-to-charge ratios detected during one or more scans of an MS of MS/MS run, a processor associated with a mass analyzer 14 can verify a previous identification. Such verification can also be accomplished by, for example, comparing data acquired at 208 to previously-acquired data stored, for example, in a research or reference data base.

At 218, 220, process 204-216 is repeated until the test analyte(s) have been exhausted and all data processed.

In other aspects, the invention provides computer programming media adapted for causing data processors to process data acquired by a mass analyzer in accordance with the methods and processes described herein. As will be readily appreciated by those skilled in the relevant arts, a wide variety of programming languages and structures may be used to implement the invention. For example, assembly language codes or high-level languages such as any of the C variants, FORTRAN, or COBOL could be used to implement a wide variety of suitable routines, modules, and applications comprising suitably-adapted machine instructions. The selection of suitable language and programming structure combinations will not trouble those skilled in the relevant arts, when they have been made familiar with this disclosure.

While specific combinations of the various features and components of the invention have been discussed herein, it will be apparent to those of skill in the art that subsets of the disclosed features and components and/or alternative combinations of these features and components can be utilized, as desired.

The above-described embodiments of the invention are intended to be examples of the present invention and alterations and modifications may be effected thereto, by those of skill in the art, without departing from the scope of the invention which is defined solely by the claims appended hereto. The invention is therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described.

What is claimed is:

1. A method of analysing ions using a mass spectrometer, comprising:
providing in a mass spectrometer an analyte comprising ions of unknown identities and concentrations;
providing in the mass spectrometer with said analyte a plurality of analytes comprising ions of known identities and concentrations;
using the mass spectrometer, acquiring data representing mass and intensity characteristics of ions comprised by the combined known and unknown analytes;
using a processor associated with the mass spectrometer, comparing the data representing mass and intensity characteristics; and
using the comparison, identifying at least one substance comprised by the analyte comprising ions of unknown identities and concentrations.

2. A method of analysing ions using a mass spectrometer, comprising:
providing in a mass spectrometer an analyte comprising ions of unknown identities and concentrations;
providing in the mass spectrometer with said analyte a plurality of analytes comprising ions of known identities and concentrations;
using the mass spectrometer, acquiring data representing mass and intensity characteristics of ions comprised by the combined known and unknown analytes;
using a processor associated with the mass spectrometer, comparing the data representing mass and intensity characteristics; and
using the comparison, verifying an identification of at least one substance comprised by the analyte comprising ions of unknown identities and concentrations.

3. Computer programming media adapted for causing a data processor to:
compare data representing mass and intensity characteristics of ions analyzed by a mass spectrometer, the data acquired by the mass spectrometer by analyzing a combination of analytes, the analytes comprising at least one an analyte comprising ions of unknown identities and concentrations and a plurality of analytes comprising ions of known identities and concentrations; and
use the comparison to identify at least one substance comprised by the at least one analyte comprising ions of unknown identities and concentrations.

4. Computer programming media adapted for causing a data processor to:
compare data representing mass and intensity characteristics of ions analyzed by a mass spectrometer, the data acquired by the mass spectrometer by analyzing a combination of analytes, the analytes comprising at least one an analyte comprising ions of unknown identities and concentrations and a plurality of analytes comprising ions of known identities and concentrations; and
use the comparison to verify an identification of at least one substance comprised by the at least one analyte comprising ions of unknown identities and concentrations.
